(19) United States
(12) Patent Application Publication
(10) Pub. No.: US 2026/0105276 A1
(43) Pub. Date: Apr. 16, 2026

(54) SELF-LEARNING MASSIVE AGENTIC SYSTEM, APPARATUS, AND METHOD

(71) Applicant: Turing Dream SL, Torrelodones (Madrid) (ES)

(72) Inventor: Juan Moran ADARRAGA, Torrelodones (Madrid) (ES)

(73) Assignee: Turing Dream SL, Torrelodones (Madrid) (ES)

(21) Appl. No.: 19/358,914

(22) Filed: Oct. 15, 2025

Related U.S. Application Data
(60) Provisional application No. 63/708,038, filed on Oct. 16, 2024.

(51) Int. Cl. G06N 3/004

(52) U.S. Cl. CPC G06N 3/004

(57) ABSTRACT

There is provided a self-learning massive agentic apparatus that receives, from a first terminal, a feedback signal corresponding to an interaction between a first user and a first agent, and retrain a world model based on the feedback signal from the first terminal. The first agent is generated based on first user context information, which includes one or more of a first user profile of the first user, a first goal of the first user and a current step in a process related to the first user.

### CROSS-REFERENCE TO RELATED APPLICATION

This application claims priority to United States Provisional Patent Application No. 63/708,038, filed on October 16, 2024, in the United States Patent and Trademark Office, the disclosure of which is incorporated by reference herein in its entirety.

### TECHNICAL FIELD

The disclosure relates to Artificial Intelligence (AI) and Machine Learning (ML), and more particularly to systems and methods for constructing, deploying, and optimizing multi-agent architectures.

### BACKGROUND

Artificial Intelligence (AI) systems range from narrow, task-specific, super-intelligent systems to broad, generalized models. At one end, for example, AI systems may include systems which achieve superhuman intelligence in specific tasks, such as chess or Go. This narrow focus allows such models to reach exceptional levels of performance, but limits its abilities to that single domain.

At the other end of the spectrum, AI systems may include systems having multimodal large language models (MLLMs) like GPT, which can handle a wide variety of tasks. However, while they excel in versatility, their intelligence remains broad but below human-level in specific domains. This reflects a tradeoff between specialization and generalization, wherein narrow AI systems can reach super-intelligence but are limited to specific tasks, while broad AI models, though highly flexible, fall short of superhuman performance.

In addition, related art multi-agent systems may rely on hand-authored rules or rigid orchestration, with little ability to autonomously evolve agent behaviors or efficiently optimize across large configuration spaces. These limitations may hinder scalability, personalization, and the ability to generalize improvements across users. Accordingly, there is a need for an improved system capable of mitigating these and other limitations.

### SUMMARY

Provided is a self-learning massive agentic system, apparatus, and method, capable of providing domain-specific mastery system and the versatility of MLLMs.

One or more aspects of the disclosure may concern multi-level AI systems that employ multimodal large language models (MLLMs) as task-performing agents, together with higher-level optimization frameworks incorporating world models and Bayesian optimization.

One or more aspects of the disclosure may concern goal-oriented optimization over agent configuration spaces and the generation of personalized, adaptive applications that evolve in real time.

According to an aspect of the disclosure, there is provide a self-learning massive agentic apparatus, including memory storing instructions; and at least one processor, wherein the instructions, when executed by the at least one processor, cause the self-learning massive agentic apparatus to: propagate, to a first terminal, a first agent based on first user context information, the first user context information comprising one or more of a first user profile of a first user, a first goal of the first user and a current step in a process related to the first user; receive, from the first terminal, a feedback signal corresponding to an interaction between the first user and the first agent; and retrain a world model based on the feedback signal from the first terminal.

The instructions, when executed by the at least one processor, may cause the self-learning massive agentic apparatus to: generate, based on the retrained world model, a second agent for a second user, the second agent generated based on a similarity between second user context information of the second user and the first user context information; and propagate the second agent to a second terminal of the second user.

The instructions, when executed by the at least one processor, may cause the self-learning massive agentic apparatus to: input the second user context information of the second user into an Agent Generation Model (AGM), the second user context information comprising one or more of a second user profile of the second user, a first goal of the second user and a current step in a process related to the second user, and wherein the AGM is configured to: identify a plurality of candidate agents from an agent space; simulate performance outcomes for the plurality of candidate agents by querying the retrained world model with information indicating the plurality of candidate agents and the second user context information; and select, based on the simulated performance outcomes, the second agent from among the plurality of candidate agents.

The instructions, when executed by the at least one processor, may cause the self-learning massive agentic apparatus to: apply a Bayesian optimization acquisition function to the simulated performance outcomes, via the AGM, to calculate a plurality of scores corresponding to the plurality of candidate agents, wherein the Bayesian optimization acquisition function is configured to assign higher scores (i) to one or more candidate agents predicted to exceed a performance threshold with respect to a predefined goal, or (ii) to one or more candidate agents having a level of uncertainty of the performance prediction that exceeds an uncertainty threshold.

The world model may include a transformer configured to: obtain latent representations based on the first user context information and the second user context information, and dynamically and implicitly identify a similarity between the latent representations.

The first agent may include a configuration for one or more first user interface (UI) components to be output at the first terminal.

The first agent may include a configuration for an interactive content to be output at the first terminal.

The first agent may include a first configuration for one or more first user interface (UI) components to be output at the first terminal, and the second agent may include a second configuration for one or more second UI components to be output at the second terminal, the one or more second UI components customized based on the one or more first UI components.

The feedback signal may include a performance result corresponding to the interaction between the first user and the first agent.

The first goal of the first user may be an improvement in a cumulative grade, the feedback signal may include a first exam score from the first user, the second agent may include a personalized lesson plan generated based on the first exam score of the first user, and wherein the propagation of the second agent comprises transmitting the personalized lesson plan to the second terminal.

According to another aspect of the disclosure, there is provide a self-learning massive agentic method, including: propagating, to a first terminal, a first agent based on first user context information, the first user context information comprising one or more of a first user profile of a first user, a first goal of the first user and a current step in a process related to the first user; receiving, from the first terminal, a feedback signal corresponding to an interaction between the first user and the first agent; and retraining a world model based on the feedback signal from the first terminal.

According to another aspect of the disclosure, there is provide a non-transitory computer-readable recording medium having instructions recorded thereon, that, when executed by at least one processor, individually or collectively, cause the at least one processor to: propagate, to a first terminal, a first agent based on first user context information, the first user context information comprising one or more of a first user profile of a first user, a first goal of the first user and a current step in a process related to the first user; receive, from the first terminal, a feedback signal corresponding to an interaction between the first user and the first agent; and retrain a world model, based on the feedback signal from the first terminal.

### BRIEF DESCRIPTION OF THE DRAWINGS

The above and other aspects, features, and advantages of certain embodiments of the disclosure are more apparent from the following description taken in conjunction with the accompanying drawings, in which:

FIG. 1 is a schematic diagram illustrating an example architecture of a self-learning massive agentic system according to one or more embodiments.

FIGS. 2A-2D are diagrams representing one or more users in the system, including one or more user profiles and one or more goals in different example scenarios, according to one or more embodiments.

FIG. 3 is a diagram representing one or more agents created by an Agent Generation Model in association with the one or more users and the one or more predefined goals, according to one or more embodiments.

FIG. 4 is a diagram illustrating the one or more users, the one or more agents, and one or more memory components that store information regarding interactions and outcomes, according to one or more embodiments.

FIG. 5A is a diagram illustrating a world model including a transformer according to one or more embodiments, and FIG. 5B is a diagram illustrating a world model including a transformer with a Gaussian process according to one or more embodiments.

FIG. 6 is a diagram illustrating a self-learning kernel within the Agent Generation Model, showing one or more iterative optimization processes, according to one or more embodiments.

FIG. 7 is a diagram illustrating an output of the self-learning kernel, including delivery of one or more agents generated by the kernel to the one or more users, according to one or more embodiments.

FIG. 8 is a block diagram illustrating a computing system environment for implementing one or more embodiments of the system, including one or more processors, a memory, and one or more communication interfaces, according to one or more embodiments.

Those of ordinary skill in the art will appreciate that elements in the figures are illustrated for clarity and have not necessarily been drawn to scale. Some actions or operations may be described in a particular order, but those of ordinary skill in the art will understand that such orders are not required, and that the disclosure is not limited thereto. It will also be understood that the terms and expressions used herein have the ordinary technical meaning as is accorded to such terms and expressions by persons of ordinary skill in the technical field unless different specific meanings have otherwise been set forth herein.

### DETAILED DESCRIPTION

The embodiments described in the disclosure, and the configurations shown in the drawings, are only examples of embodiments, and various modifications may be made without departing from the scope and spirit of the disclosure.

According to one or more embodiments, the disclosure provides a self-learning massive agentic system. The self-learning massive agentic system may be referred to as a system or an agentic system. For example, the system is configured to generate and optimize a wide variety of applications and agents based on real-world feedback. For example, the system is configured to generate and optimize a wide variety of applications and agents in a manner that is responsive to real-world feedback. According to an embodiment, the system is configured to generate and optimize a wide variety of applications and agents in real-time. The system may be a general-purpose, multi-agent artificial intelligence system that is highly configurable and flexible. The platform may be configured to replace isolated copilots with governed swarms of autonomous, hyper-personalized agents that plan, coordinate, and act to achieve predefined goals. While terms like “user” are used for simplicity, the disclosure is not limited thereto, as other entities, not necessarily human, could be the actors in using the system. For example, “user” may encompass any intelligent agent, which may include human intelligence or artificial intelligence (e.g., AI agent).

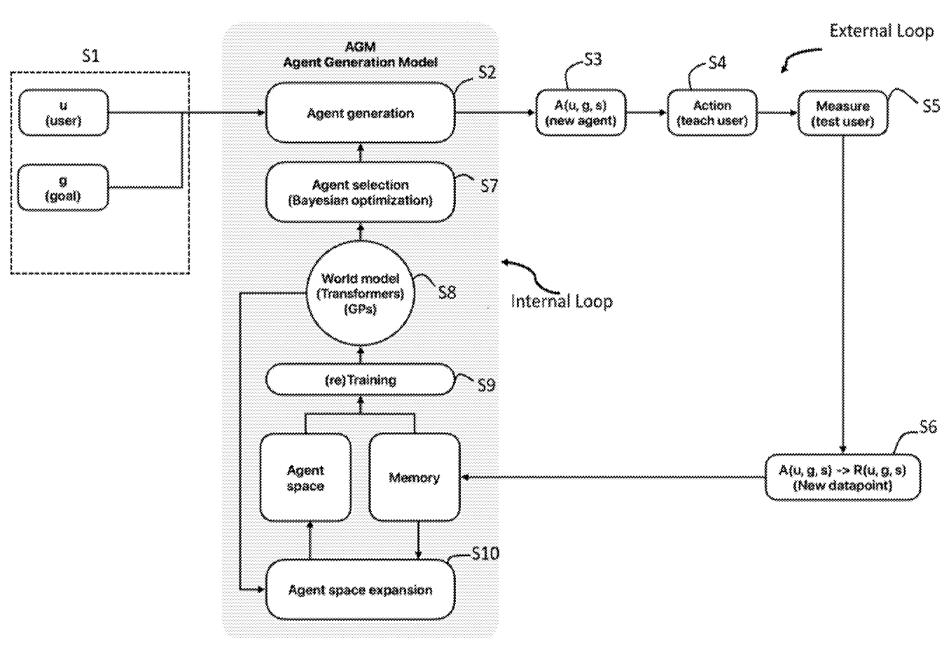

According to an embodiment, an AI agent may be an autonomous or semi‑autonomous software entity composed of (or defined by) features (or elements) including, but not limited to, instruction set, LLM invocations, inter-agent messaging, tool and functioning calls, and resources as illustrated in FIG. 1. According to an embodiment, the AI agents may be formed by various combinations of the features including, but not limited to, instruction set, LLM invocations, inter-agent messaging, tool and functioning calls. For example, the instruction set may include, but is not limited to, prompts, system messages and role definitions. For example, LLM Invocations may include, but is not limited to, calls to general or specialized language models. For example, Inter‑agent messaging may include, but is not limited to, protocol for multi‑agent collaboration. For example, tool & function calls may include, but is not limited to, dynamic selection of function libraries or external tools. For example, resources may include, but is not limited to, scoped data, domain knowledge and long‑term memory. However, the disclosure is not limited thereto, and as such, the AI agent may be include (or formed of) one or more other features, or one or more features described above may be omitted.

According to an embodiment, the AI agent may be implemented to receive inputs and produce output. According to an embodiment, the AI agent may accept (as inputs) user goals and multimodal/context and produce (as outputs) plans, tool calls, actions, and responses. However, the disclosure is not limited to the inputs and outputs illustrated above. In an example scenario involving education, the input may be “Improve algebra exam score”, and the outputs may be personalized lessons, practice, assessments, etc. In this case, a key feedback signal may be exams/academic results. In another example scenario involving corporate sales, the input may be “Increase quarterly close rate”, and the outputs may be coaching content, customer relationship management (CRM)‑connected actions, etc. In this case, a key feedback signal may be sales deal closure.

According to one or more embodiments, the system may be configured to apply one or more data-driven methods, including Bayesian optimization and user context analysis, to autonomously customize an application configuration for each user and a specific predefined goal corresponding to the user. For example, the system analyzes the user context information of a plurality of users to identify similarities between the user, which functions to dynamically classify users into clusters. Although the term “cluster” or “clustering” may be user in the disclosure, the embodiments are not necessarily limited to clustering methods, but instead, the term “cluster” or “clustering” may refer to the dynamic classification of the users by system during analysis of the user context of a plurality of user.

According to one or more embodiments, the system may operate across a layered, cloud-native architecture designed for scalability. According to an embodiment, the architecture of the system may be structured into three logical layers that may collectively enable the design, deployment and operation of Multi-Agent-Based Applications (MABA). However, the disclosure is not limited to thereto, and as such, the architecture of the system may be structure in a different manner, and may be configured to design, deploy or perform other operations or applications.

According to an embodiment, the three logical layers may include layer 1, which corresponds to cloud infrastructure and/or services, layer 2, which corresponds to technology platform (e.g., agentic runtime and development tooling) and layer 3, which corresponds to MABA applications (e.g., no-code configurations and/or domain logic). However, the disclosure is not limited thereto.

According to an embodiment, the layer 1 (e.g., cloud infrastructure layer) may provide an environment to run a platform (e.g., the technology platform of layer 2). For example, the platform may run on cloud with selected cross‑cloud services to avoid single‑vendor dependency. According to an embodiment, the layer 1 may be responsible for identity, storage, compute, scalability, databases, LLM hosting, cybersecurity, data warehousing (DW) & analytics, continuous integration (CI), continuous delivery/continuous deployment (CD) and/or monitoring. However, the disclosure is not limited thereto. For example, these services may provide elastic scalability, global availability and enterprise‑grade security that meet ISO‑27001, SOC‑2 and GDPR requirements. According to a embodiment, the layer 1 may be implement on Microsoft Azure®.

According to an embodiment, the layer 2 (e.g., technology platform layer) may provide a general-purpose, AI-native framework where advanced multi-agent-based applications (MABA) can be easily composed. For example, the layer 2 may implement a differentiator by abstracting AI complexity behind declarative, no-code constructs.. According to an embodiment, the layer 2 may be responsible for agent execution, orchestration, planning, memory, governance, user interface, AI Agent Generation Model (AGM), and/or AI Dev Tools. According to an embodiment, the AGM may govern an orchestration of one or more agents. However, the disclosure is not limited thereto. According to an embodiment, the layer 2 may facilitate an environment, in which, enterprise teams — even those without in-house AI engineers — can configure, deploy, and iterate on advanced multi-agent-based applications, dramatically reducing time-to-market for new AI solutions.

According to an embodiment, the layer 3 (e.g., MABA layer) may be a top layer, in which, domain experts compose MABAs. For example, the Multi-Agent-Based Application (MABA) is composed of multiple autonomous agents that interact to perform sophisticated tasks. Unlike related art monolithic systems or applications, MABAs are modular, composable, self-improving, and adaptive—enabling faster development, greater scalability, and more resilient AI solutions across dynamic environments. Moreover, by abstracting away the complexity of agent design, the MABA layer allows a user (e.g., a company, a student, or other entities) to focus on logical goals (e.g., education goal, business logic), while the platform handles reasoning, memory, self-improvement, and agent collaboration. According to embodiment, the MABA applications may include, but is not limited to, Business-to-Consumer (B2C) applications, Business-to-Business (B2B) applications, and Business-to-Business-to-Consumer (B2B2C) applications. For example, the MABA applications may include, but is not limited to, educational application, healthcare applications, banking applications, insurance applications, or retail applications, etc.

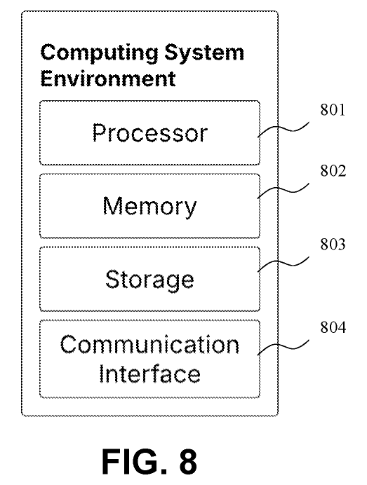

FIG. 8 is a block diagram illustrating a computing system environment for implementing one or more embodiments of the system, including one or more processors 801, memory 802, storage 803 and one or more communication interfaces 804, according to one or more embodiments.

According to one or more embodiments, the system may be implemented in one or more servers, one or more apparatus, one or more terminals, one or more storages, or an network infrastructure including a combination of the one or more servers, the one or more apparatuses, the one or more terminals, the one or more storages, and/or other devices/components. For example, the system may include one or more servers communicating with one or more terminals, but the disclosure is not limited thereto. For example, the server, the apparatus, and/or the terminal may include one or more processors 801 configured to control its overall operation. The one or more processors may include, for example, a central processing unit (CPU), a graphics processing unit (GPU), or other hardware accelerators. The one or more processors may be implemented as a System on Chip (SOC), a field programmable gate array (FPGA), or an application-specific integrated circuit (ASIC). Additionally, although terms such as “servers”, “apparatus” or “terminal” are used, the disclosed embodiments may be implemented using any type of endpoint.

According to one or more embodiments, the memory 802 may store computer program instructions that, when executed by the one or more processors, cause the apparatus to perform the operations described herein. The memory may include a random access memory (RAM), for example a static random access memory (SRAM), a dynamic random access memory (DRAM), a synchronous dynamic random access memory (SDRAM), or a double data rate synchronous dynamic random access memory (DDR SDRAM), but the disclosure is not limited thereto.

According to one or more embodiments, the storage 803 may include a non-volatile data storage device, for example a hard disk drive (HDD), a solid-state drive (SSD), a magnetic tape, or an optical disc. The storage may be configured to store, for example, the Memory Service data, the agent space definitions, and one or more machine learning models.

According to one or more embodiments, the communication interface 804 may include one or more input/output (IO) interfaces for receiving and outputting information or data

According to one or more embodiments, the system may employ a two-level AI architecture including a first-level (L1) AI and a second level (L2) AI. According to one or more example embodiments, the first-level AI may utilize multimodal large language models (LLMs). For example, LLMs serve as the primary intelligence for agents, enabling the agents to understand and perform tasks using multimodal inputs. In some embodiments, the LLMs from either commercial or open-source sources may be used. According to one or more example embodiments, the second-level AI may utilize results from the first-level AI. According to one or more example embodiments, the second-level AI layer may be configured to manage, optimize, and evolve the first-level AI models and the agents themselves. For example, he second-level AI may continuously analyze the performance of the first-level agents, making iterative improvements through a closed feedback loop to enhance the overall performance and intelligence of the system. According to an embodiment, this division into the first-level AI and the second-level AI may allow scalability across a large population of agents, coordinated through centralized feedback mechanisms. According to an embodiment, the first-level agents may be generated as autonomous or semi-autonomous software entities, wherein each agent is composed of elements or features including: (i) an Instruction Set including one or more high-level directives or prompts; (ii) one or more Multimodal Large Language Model (MLLM) Invocations; (iii) one or more Inter-Agent Messaging protocols that allow an agent to collaborate with another agent in a swarm; (iv) one or more Tool and Function Calls that define an external library or an API that the agent is permitted to utilize; and (v) one or more Resources and data, for example a scoped knowledge base or a UI component that the agent is permitted to access. However, the disclosure is not limited thereto, and as such, the agents may be implemented or composed of one or more other elements.

According to one or more embodiments, by integrating the operations and functions of the first-level AI and the second-level AI, the system may enable a continuous self-learning process. For example, a first-level AI agent may operate autonomously to perform a task, and a second-level Kernel, with its AGM and world model, may ensure that the design and deployment of the first-level AI agent are guided by predictive modeling, uncertainty estimation, and goal-driven optimization, because the second-level AI’s optimization is goal-driven, based on specific objectives set within the platform. This architecture may address a deficiency of a related art multi-agent framework by combining scalability, adaptability, and self-learning capabilities within a platform.

According to one or more embodiments, the system may further include an agent space, which serves as a dynamic collection of all possible agent combinations. A human developer may use a no-code or a low-code Governance Console to define a possibility space rather than a single, static application. In doing so, a user or a developer may provide the system with a catalog of permissible options, such as a first wave of reusable building blocks including instructions, policies, flows, content, and a first set of user interface (UI) components. From this catalog, the AGM may assemble, personalize, and iteratively optimize a runnable application for each user and goal.

FIG. 1 is a schematic diagram illustrating an example architecture of a self-learning massive agentic system according to one or more embodiments.

According to an embodiment, one or more operations of the system may be implemented by an interconnected feedback structure, which may be described as an external loop for data acquisition and an internal loop for optimization. For better understanding, in FIG. 1, elements and arrows outside the shaded rectangle in FIG. 1 will be referred to as the “external loop,” and those inside the shaded rectangle will be referred to as the “internal loop.”

In the external loop, a first user (U) may set a goal (G). In operation S1, the agent generation model AGM may receive input. For example, the AGM may receive parameters related to a user. For example, two parameters user and goal (U, G) may be input to the AGM. However, the disclosure is not limited thereto, and as such, according to another embodiment, other parameters may be input to the AGM. For example, a current step (S) in the process may be included as one of the parameters input to the AGM. According to an embodiment, the user (U), the goal (G), and the current step (S) in the process parameters may be referred to as user context (U, G, S). However, the disclosure is not limited thereto, and as such, according to another embodiment, one or more other information or parameters may be included to define the user context.

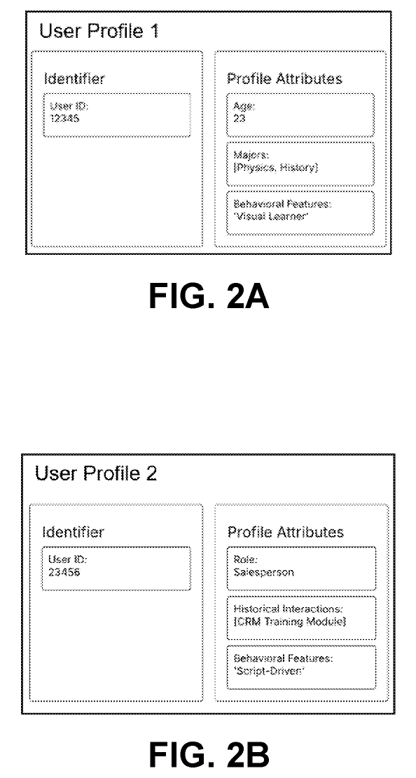

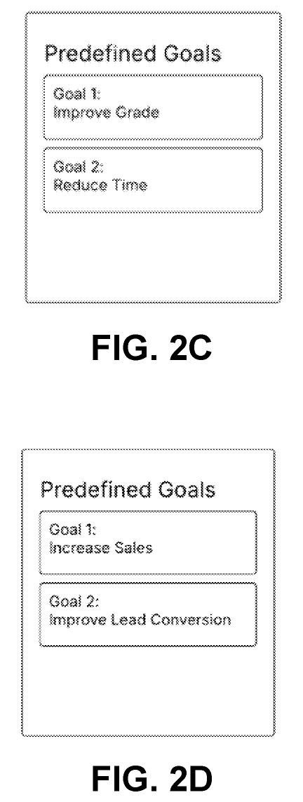

According to an embodiment, the parameter ‘U’ may include information related to a user. The information related to a user may include, but is not limited to, a user identification (e.g., user ID), user attributers. For example, the information related to the user may be as user profile. For example, a user may have a user profile 1 as illustrated in FIG. 2A in a first example scenario, and a another user may have a user profile 2 as illustrated in FIG. 2B in a second example scenario. However, the disclosure is not limited thereto, and as such, the user profile may include other information. According to an embodiment, the parameter ‘G’ may include a goal of the user. However, the disclosure is not limited thereto, and as such, the parameter ‘G’ may include one or more goals of the user. For example, one or more goals of the user in the first example scenario may include improving grade or reduce time as shown in FIG. 2C, and one or more goals of the user in the second example scenario may include increase sale or improve lead conversation as shown in FIG. 2D. However, the disclosure is not limited thereto, and as such, according to an embodiment, the goal of the user may be included in the user profile. According to an embodiment, the parameter ‘U’ may represent a current step in a process. For example, the current step may be the user’s position in a new multi-step workflow provided by the AGM. For example, in an education scenario, the current step may be a first lesson provided by the agent for a class having a plurality of lessons to be administered. However, this is merely an example, but the disclosure is not limited thereto.

According to an embodiment, in operation S2, the AGM may generate a new agent based on the user, the goal, and the current step in the process (U, G, S). For example, the new agent may include one or more agents configured to perform an action. For example, the AGM may generate a swarm of agents. According to an embodiment, the AGM searches a large agent space, and generates/creates hyper‑personalized agents per user (U) and goal (G) by selecting instructions, LLM(s), tools/APIs, resources, other agents and collaboration patterns to maximize success for (U,G,S).

According to an embodiment, although generated agents may not be written by humans, the platform provides no‑code tooling, AI tooling and governance consoles for domain experts to configure first wave of instructions, policies, flows, and content. After the initial configuration performed by the human expert, the system evolves the agents by selecting the best combinations of instructions, M-LLMs, tools, resources, and communication with other agents.

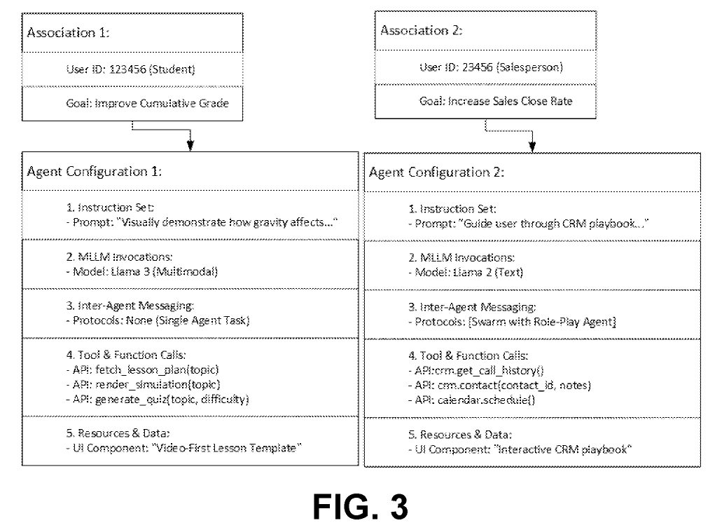

FIG. 3 is a diagram illustrating one or more agents created by an Agent Generation Model in association with the one or more users and the one or more predefined goals, according to one or more embodiments. For example, in a first example scenario, a first agent configuration 1 may be generated for a user based on the user context (U, G, S) of the user. In another example scenario, a second agent configuration 2 may be generated for another user based on the user context (U, G, S) of the another user.

According to an embodiment, in operation S3, the agent performs an action. For example, the agent may perform the action on a user terminal. For example, the agent may implement or facilitate an environment to teach a user. For example, the agent may generate or output information (e.g., modules) to facilitate an interactive learning with the user. However, the disclosure is not limited thereto, and as such, the agent may be tasked or configured to perform another task. According to an embodiment, users and agent may interact or converse via web/mobile UIs, and agents act autonomously by invoking tools/APIs and collaborating with other agents (multi‑agent orchestration). However, the disclosure is not limited thereto.

According to an embodiment, in operation S4, feedback information may be obtained. For example, the agent may measure a performance of the user by testing the user, which produces a result (e.g., a measurable result). In operation S5, a new data point may be obtained based on the feedback information or the result. The new data point may include an agent (or a swarm of agents) and its result (A (U, G, S) -> R (U, G, S)). In operation S6, this new data point may be sent back to the AGM, closing the “external loop.” For example, the agent (or a swarm of agents) may transmit the new data point back to the AGM.

According to an embodiment, data acquisition, such as the acquisition of the test results and new data point, may occur at the point of user interaction or through background telemetry. According to an embodiment, the new data point may include the interaction between the user and the agent, and the new data point is transferred into a Memory Service.

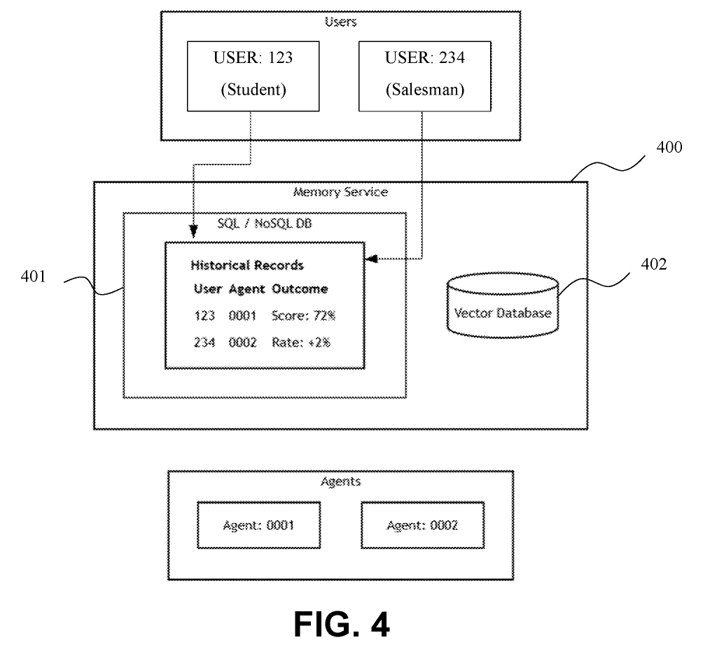

FIG. 4 is a diagram illustrating the one or more users, the one or more agents, and one or more memory components that store information regarding interactions and outcomes, according to one or more embodiments. According to one or more embodiments, the system may employ a memory component, which may be referred to as the Memory Service 400, serving as a central repository for historical data. The memory may be implemented as a hybrid data store, including an operational store 401 (e.g., a SQL or NoSQL database) for managing interaction records and a vector database 402 for storing vectorized embeddings, which may be retrieved for similarity searches. For example, the memory component may store historical record for a user 123 in a first example scenario (e.g., related to education) and another user 234 in a second example scenario (e.g., related to sales). However, the disclosure is not limited thereto, and as such, the memory component may store various records of various users.

However, the disclosure is not limited thereto, and as such, according to an embodiment, the memory service 400 may implicitly store information in latent space. According to an embodiment, the memory stores all historical data on user interactions, which may include at least one of: a plurality of user profiles, a plurality of agent configurations, or a plurality of performance outcomes corresponding to interactions between users and agent configurations. For example, a historical data record may link a user profile and an agent configuration to a corresponding performance outcome. The memory may also support a global knowledge graph for cross-context sharing. This memory provides the historical foundation on which the world model and the AGM operate. According to an embodiment, the memory may store user record information corresponding to each user. The user record information corresponding to each user may include, but is not limited to, a user profile, such as a first user profile (of a first user) or a second user profile (or a second user), which may include demographic information, historical interactions, and derived behavioral features. The user record information may further include additional information collected from the user’s initial interaction, such as basic personal data, age, interests, or results from tests, as well as information about a user’s prior goal or time spent engaging with a different modality. The memory may also store an agent-configuration identifier and an associated performance outcome, thereby linking a result directly to an agent that produced the result.

According to one or more embodiments, the world model may be trained continuously in near real-time on data points collected through system operation. According to an embodiment, the new data point illustrated in FIG. 1 may include an agent and its result, which can be expressed as a mapping from an agent configuration corresponding to the user context to a performance outcome corresponding to the user context: A(U, G, S) R(U, G, S). In this mapping, 'A' represents the specific Agent configuration deployed, 'U' represents the User profile, 'G' represents the predefined Goal, 'S' represents the current Step in the process, and 'R' represents the measurable Result or performance outcome.

According to one or more embodiments, the training process involves retraining the world model using the new performance result. This process may be self-supervised. For example, the performance result, the first agent configuration, and the user context may be used as token input to the world model, and the world model may be retrained based on the token input.

According to one or more embodiments, the internal loop in FIG. 1 illustrate the operations of the AGM, which simulates and selects agents without continuous real-world interaction. According to an example embodiment, in operation S7, the AGM continuously performs Bayesian optimization to deliver the best possible outcome to the user (e.g., teaching) as quickly as possible.

According to one or more embodiments, the selection of an agent may be driven by a Bayesian optimization process guided by an acquisition function. For example, the acquisition function may include, but is not limited to, Expected Improvement (EI) or Upper Confidence Bound (UCB), although the disclosure is not limited thereto. The AGM may apply the acquisition function to the simulated performance outcomes to calculate a score for each candidate. The acquisition function is configured to assign higher scores to candidate agent configurations predicted to exceed a performance threshold with respect to the predefined goal (exploitation), or to candidate agent configurations having a level of uncertainty of the performance prediction that exceeds an uncertainty threshold (exploration). For example, an agent configuration with a modest predicted outcome but a high uncertainty may be selected if the acquisition function determines that the potential information gain is worth the cost of experimentation. By iteratively applying this process, the AGM may converge on an agent configuration that maximizes goal-driven performance while minimizing unnecessary user experimentation. However, the disclosure is not limited thereto, and as such, the selection of an agent may be implemented using another approach. For example, other approaches may include, but is not limited to, reinforcement learning and transformer‑based methods. In some example cases the reinforcement learning and transformer‑based methods may be implement with Gaussian processes for uncertainty, alongside Bayesian optimization.

According to one or more embodiments, the system may include a world model that predicts what will happen if the system delivers an action before execution. The world model may provide not only an expected outcome but may also provide a measure of uncertainty of the performance prediction. According to an embodiment, the world model may perform a prediction and/or a measure of uncertainty using techniques, including, but not limited to, reinforcement learning, transformers, and/or Gaussian process based uncertainty modeling, machine learning, statistic learning, deep learning, neural network systems, etc. However, the disclosure is not limited to these techniques, and as such, various combination of these and other techniques may be implemented by the world model.

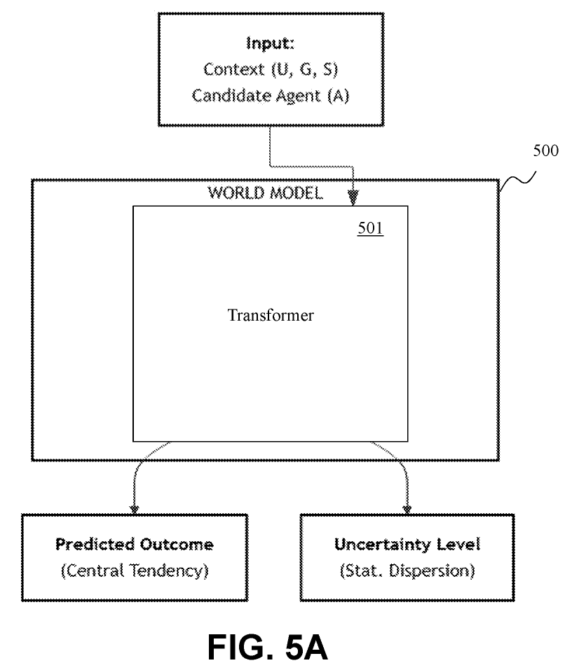

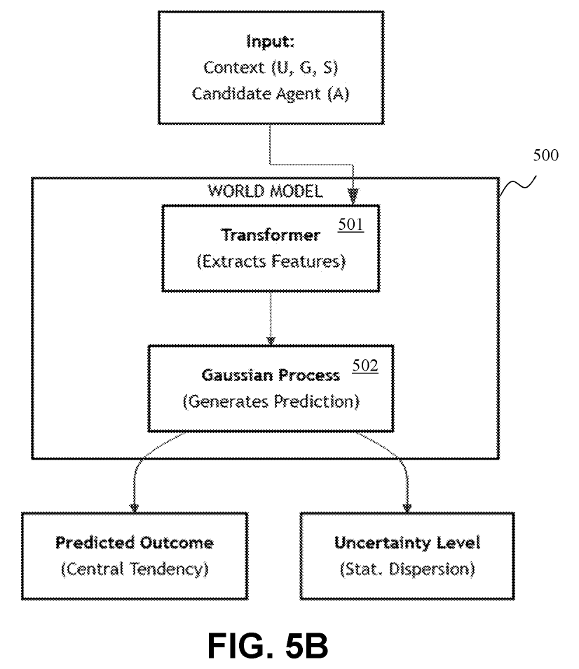

FIG. 5A is a diagram illustrating a world model including a transformer according to one or more embodiments. According to an example embodiment, a world model 500 may include a transformer 501configured to extract all relevant information from the memory. For example, the transformer 501 is a deep learning model designed to process sequences of data in parallel, while capturing relationships between all elements in the sequence using a mechanism called self-attention. This process provides not only the expected outcome of a specific action (e.g., teaching) but also the level of uncertainty of the prediction. For example, the transformer may indicate certainty of predictions via output probabilities.

According to an embodiment, the transformer 501 may receive first user context of a first user and one or more second user contexts respectively corresponding to one or more second (e.g., other) users and identify a similarity between the first user context and the one or more second user contexts. For example, the transformer 501 may obtain latent representations based on the first user context and the one or more second user contexts, and dynamically and implicitly identify a similarity between the latent representations. According to an embodiment, the transformer 501 may calculate the similarity using methods such as Cosine Similarity or Euclidean Distance, for example, although the disclosure is not limited thereto. As such, according to an embodiment, any form of similarity measurement may be used to compare any types of data associated with different entities. However, the disclosure is not limited thereto, and as such, according to an embodiment, other methods and techniques may be applied to (implemented with) the world model to obtain a level of certainty in the predicted outcome. For example, the transformer may include one or more additions such as, but not limited to, a softmax layer, Monte Carlo (MC) dropout, Bayesian methods, ensemble models, or variational layers to obtain a measure of uncertainty in its predictions. However, the disclosure is not limited thereto, and as such, various combination of these and other techniques may be implemented by the world model.

FIG. 5B is a diagram illustrating a world model including a transformer with a Gaussian process according to one or more embodiments. For example, the transformer 501 may be further implemented with a Gaussian process 502. For example, the Gaussian process 502, working in conjunction with the transformer 501, may allow the system to make more accurate predictions as it collects more measurements, even for users (U, G, S combinations) with no prior data. In other words, the AGM predicts what will happen with a new user based on its knowledge of similar users. For example, the Gaussian process, working in conjunction with the transformer, provides not only an expected outcome, based on a measure of central tendency of a probability distribution, but also a corresponding level of uncertainty, based on a measure of statistical dispersion of the probability distribution. However, the disclosure is not limited thereto, and as such, the self-learning massive agentic system may include other types of algorithms to determine the level of uncertainty according to another embodiment of the disclosure.

According to an example embodiment, in operation S8, the selection of the agent may be based on a world model. For example, the world model may predict an outcome (e.g., what will happen if the system delivers an action to a user (e.g., teaching a student)) before the action is executed. According to an embodiment, the world model is built from data related to users, their goals, and the actions delivered to the user (e.g., teaching actions). According to an embodiment, the system creates a simulation of what may happen with the user, allowing the AGM to perform Bayesian optimization without directly interacting with the user. However, the disclosure is not limited thereto, and as such, according to another embodiment, the selection of the agent may be performed without using the world model, or by using another model.

According to an embodiment, in operation S9, the world model be trained or retrained using information from an agent space and Memory. According to an embodiment, the memory may store all historical data on users and interactions, along with assessments, tests, and other evaluations. Moreover, any additional information collected from the user's initial interaction, such as basic personal data, age, interests, or results from tests unrelated to learning, is stored in the memory. According to an example embodiment, any user-related data may be retained in the memory for future use.

According to an embodiment, the agent space is a collection of all possible agent combinations from which the AGM selects one or more combinations of agents based on the user context (U, G, S). For example, the AGM selects a specific combination of agents that fit a user, a goal of the user, and a step in process of the user.

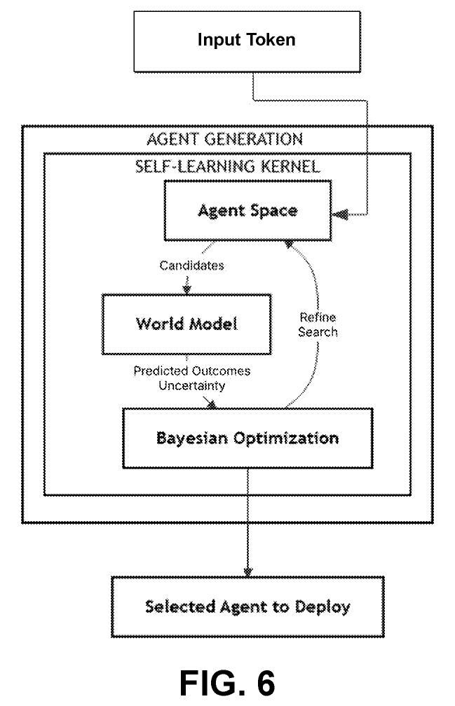

FIG. 6 is a diagram illustrating a self-learning kernel within the Agent Generation Model, showing one or more iterative optimization processes, according to one or more embodiments.

According to an embodiment, in operation S10, the agent space may continue to dynamically evolve. For example, a process, which may be referred to as an agent space Expander, may analyze insights from the world model and memory to synthesize new agent configurations, such as a new class of agents specialized in delivering a hybrid lesson plan. This expansion ensures that the system is not limited to a fixed design space defined at initialization and can discover novel strategies beyond the initial configuration. For example, in this manner, the system ensures that the agent space continuously expands, creating more agent combinations. According to an embodiment, the system uses optimization to avoid unnecessary experimentation with users. According to an embodiment, the system experiments only with the U, G, S combinations that have the highest probability of success.

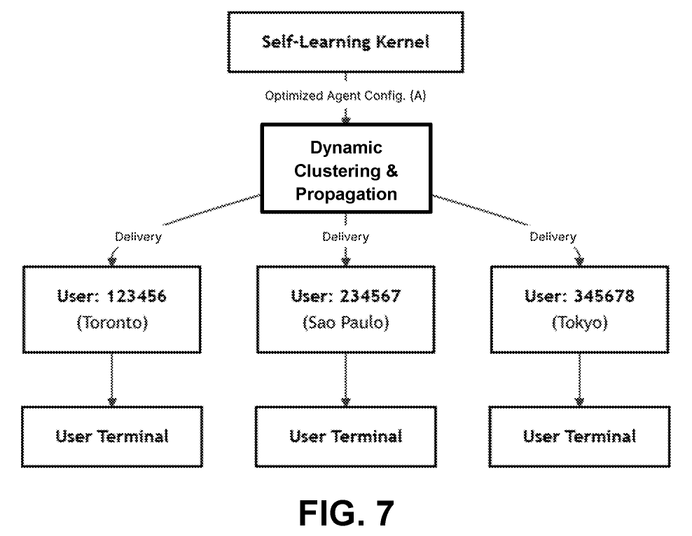

FIG. 7 is a diagram illustrating an example output of the self-learning kernel, including delivery of one or more agents generated by the kernel to the one or more users, according to one or more embodiments.

According to an embodiment, the optimization of the system may be based on an observation or recognition users are not infinitely different. For example, the system analyzes the user context information of a plurality of user to identify similarities between the user, which functions to dynamically classify users into clusters. According to an example embodiment, this is not a fixed classification process, but rather a continuous AI-driven approach where user similarities are incorporated in real time. Instead of treating each user as entirely unique, the system recognizes patterns, allowing solutions that work for one user to be generalized to others with similar profiles. For example, this integration of proximity ensures that a first user (or a first entity) can benefit from improvements made through an interaction between the system and a second user (or a second entity) who is unrelated but is similar to the first user. For example, as illustrated in FIG. 7, a user in Toronto can instantly benefit from improvements made to the system based on an interaction between the system and a dynamically identified similar user in São Paulo. For example, the system dynamically incorporates similarity/proximity so successful strategies transfer to similar users in real time.

According to an embodiment, proximity (or similarity) in user context enables the system to facilitate instant transfer of improvements to new users/goals. For example, the system may recognize some students are more visual and prefer explanations with photos and videos, while others prefer text-only explanations. The system may also determine, for each of these profiles and for a given topic, which type of image or text has had the greatest impact on their learning and assessments. In the manner, the system may leverage that knowledge acquired from some users for the rest of the users within the dynamically identified cluster based on the proximity.

According to one or more embodiments, by combining a real-time training, a probabilistic prediction, a Bayesian optimization, a dynamic classification users based on user context, the system may provide a framework for a continuous improvement. The system is capable of high performance across various applications through continuous self-learning and adaptation. This may ensure that the self-learning massive agentic system evolves and tailors an agent behavior to an individual user while also benefiting from a scale of an aggregated interaction across a population. Optimizations discovered for one user are immediately generalized to similar users globally, accelerating the rate of improvement as the user base scales.

According to one or more embodiments, by combining a real-time training, a probabilistic prediction, a Bayesian optimization, and a dynamic classification users based on user context, the system may provide a framework for a continuous improvement, capable of high performance across various applications through self-learning and adaptation.

According to one or more embodiments, the deployment architecture may support a wide range of scalability features. For example, an elastic scaling in the cloud may enable the system to handle a massive number of simultaneous users and agents, while a shared database may ensure that a historical record is stored and retrieved efficiently. An agent execution may be distributed across a plurality of geographic regions to reduce a latency and ensure a compliance with a regional data regulation. A load balancer and an autoscaling policy may dynamically allocate a compute resource based on a demand.

According to one or more embodiments, the system may be deployed across a distributed, cloud-native computing infrastructure. The cloud-infrastructure layer may be implemented using managed cloud services. In a non-limiting example, such services may include Azure AD B2C for identity, Azure Storage Accounts for object storage, Azure Kubernetes Service for container orchestration, a mix of compute instances including vCPUs, vGPUs, and vTPUs, databases such as Azure Cosmos DB (NoSQL) and Azure Database for PostgreSQL, and Cloudflare CDN + WAF for cybersecurity.

According to one or more embodiments, the deployment architecture may support a wide range of scalability features. For example, an elastic scaling in the cloud may enable the system to handle a massive number of simultaneous users and agents, while a shared database may ensure that a historical record is stored and retrieved efficiently. An agent execution may be distributed across a plurality of geographic regions to reduce latency and ensure compliance with regional data regulations. A load balancer and an autoscaling policy may dynamically allocate compute resources based on demand. Further, an enterprise may tailor a deployment topology to its needs, for example, a fully cloud-hosted, a hybrid, or a localized deployment.

According to one or more embodiments, a technology platform layer may provide an agent runtime and an orchestration environment. Agents may execute in the agent runtime as state-machines with streaming multimodal I/O and validation. Platform services may include a Planner & Scheduler, a Tool Adapter Library for integrating an external API, a Hallucination Guardrail for mitigating an unreliable output, a Smart UX SDK for user interfaces, and the core level 2 (L2) components. For example, the core level 2 components may include, but is not limited to, the AGM, the world model, and the Memory Service. The system may return results and outputs via one or more interfaces, including conversational UIs, API calls, and dashboards.

However, the disclosure is not limited thereto, and as such, although UI components are used as an example in the disclosure, the configuration of an agent is not limited to an user interface or user interface parameters. As such, according to an embodiment, the configuration of an may include other parameter, including, but not limited to other behavioral or cognitive parameters. According to some example embodiment, the configuration of an agent may include, but are not limited to or more of: interface definitions including graphical user interfaces; voice interfaces; application programming interfaces (APIs); and messaging schemas; behavioral policies including instructions, tool use policies, routing policies, and action selection strategies; safety or compliance constraints; access permissions for external tools; and parameter settings including prompts, memory contents, model or fine tuning weights, hyperparameters, and resource allocations; Multilingual Label System (MLLS) used; data used; or other Agents used. According to some example embodiment, the configuration of an agent may include, content, which may be provided a user or a terminal. For example, the content may include, but is not to, audio content, or video content output through an existing video provision application (such as video conferencing application) or audio provision application (e.g., phone application or radio application).

According to one or more embodiments, the framework may be designed for robust, enterprise-grade deployment, maintaining data integrity and privacy through system-level safeguards such as network segmentation. The Governance Console may provide an administrator with an audit trail and other functionality to manage the system’s autonomous behavior. The architecture may also support non-functional requirements such as offline resilience with data synchronization, and the system may be configured to comply with international data-privacy and security standards, for example ISO-27001, SOC-2, and GDPR.

According to one or more embodiments, the platform may be configured to be LLM-agnostic, supporting model selection and hosting from various sources. As such, other machine learning model optimization techniques, such as fine-tuning, distillation, or quantization, may be integrated at the model hosting layer.

According to one or more embodiments, safety, governance, and compliance mechanisms may be built into the deployment layer to ensure the system operates reliably and maintains data integrity and privacy. Protections may include network segmentation and identity management services. A centralized Governance Console may provide an administrator with an audit trail, visibility into agent actions, and other functions to manage the system’s autonomous behavior. Safety mechanisms may include a rule-based or learned veto system configured to override an agent output that exceeds a risk threshold, or a fallback behavior, such as reverting to a baseline strategy, triggered by a high uncertainty estimate from the world model.

According to one or more embodiments, the system’s customization pipeline may generalize to a desktop-class application running on various operating systems or a cross-platform runtime. The framework may treat each desktop application as a declarative bundle of configurable elements. A developer may use the Governance Console to seed the agent space with a library of permissible windowing patterns, screen templates, and native UI component palettes. The AGM may then compose and iteratively optimize a per-user application configuration using the same underlying world model and Bayesian-optimization loop.

According to one or more embodiments, the decision-making surface for the AGM may be expanded in a desktop scenario. For example, the AGM may optimize a user’s command surface by choosing between a traditional menu, a toolbar, or a modern command palette. The Tool Adapter Library may be extended to include rich OS integrations, which may allow the AGM to compose a toolchain that leverages a filesystem, clipboard, system notifications, or a sandboxed plugin architecture.

According to one or more embodiments, to illustrate the pipeline, an example use case of a learning application is described. For example, a first user (U), who is a first student, may begin a lesson at a current step (U) with a goal (G) of improving a cumulative grade. The AGM may enter an exploration mode and query the world model to select and deploy an initial agent configuration. If the first student struggles and the resulting quiz score is below a threshold, the new data point is sent back to the AGM, and the score is stored in Memory. For a next lesson, the AGM may query the updated world model, which may predict a different strategy is more effective (for example, a video-first approach may be used for lessons). The system may then leverage the first student’s experience to improve an outcome for another student (e.g., a second student) through a generalization and a cross-user transfer. The system may evaluate the first student’s interaction profile and, by recognizing patterns, associate the first student with one or more other second student based on a similarity between the first student and the one or more other second students. When another student with a similar profile requests for an agent (e.g., a lesson), the world model, trained on the prior first student's data, may predict a high success rate for a video-first approach. The AGM may therefore bypass a trial-and-error phase and immediately deploy a video-first lesson for the new student as a second agent configuration, which is then propagated to the second student's terminal. Over time, the system may analyze accumulated data and synthesize a new composite screen template that combines an animation with a guided simulation, which then becomes a new option in the agent space. However, the disclosure is not limited thereto, and as such, according to another example embodiment, the world model, trained on the first student's data, may leverage the first student’s experience in the first scenario (e.g., in a Math class) to improve an outcome for the same student in another similar scenario (e.g., in a Physics class).

According to one or more embodiments, to illustrate the pipeline's application, an example use case of a corporate sales coaching application is described. A first user, who is a salesperson, may begin a training with a predefined goal of increasing their close rate at a current step. The AGM may deploy an initial agent configuration. The system may monitor the salesperson's subsequent performance in a CRM and receive a performance result indicating an absence of improvement. This feedback is stored in Memory, and the world model is retrained. The AGM may then dynamically adapt by generating a second agent configuration featuring a text-based playbook integrated directly with the CRM for practice. The system may then generalize this learning to a second user on the team by identifying a similarity between the first user and the second user , and generating a text-plus-CRM training path for the second user. For example, the system may identify a similarity between a first user profile of the first user and a second user provide of the second user Over time, the system may discover an emergent pattern—for example, that performance improves when a text-based script is followed by an AI-coached role-play simulation—and synthesize a new multi-step workflow that combines a text lesson with an interactive role-play agent, which then becomes a new coaching tool in the agent space.

According to one or more embodiments of the disclosure, the self-learning massive agentic system provides for improvement in technical and practical application over related art system at least in the following manner:

Hyper personalization & optimization at scale: AGM creates specialized agents per user/goal and optimizes them over time.

Scale accelerated self-improvement: In case of more uses, the system provides for faster improvement via reinforcement learning, transformers, and/or Gaussian process based uncertainty modeling, or any other techniques including, but not limited to, machine learning, statistic learning, deep learning, neural network systems, etc.

Ultra specialization & knowledge atomization: Thousands of narrow, high quality agents minimize hallucinations and raise precision.

Long term Memory & Hyper personalization: Persistent per user memory and cross agent knowledge sharing improve relevance and consistency.

Proactivity vs. passive copilots: Agents plan, coordinate, and act to achieve goals without step by step prompting.

Democratize AI: Create production grade agents without AI engineers using declarative, no code/low code tools.

However, the disclosure is not limited to these improvements, and as such, other improvements may be achieved by the inventive concept of the disclosure.

Those skilled in the art will recognize that a variety of modifications, alterations, and combinations may be made with respect to the above-described embodiments without departing from the scope of the disclosure. Such modifications, alterations, and combinations are to be viewed as being within the scope of the disclosure.

What is claimed is:

1. A self-learning massive agentic apparatus, comprising:
memory storing instructions; and
at least one processor,
wherein the instructions, when executed by the at least one processor, cause the self-learning massive agentic apparatus to:
propagate, to a first terminal, a first agent based on first user context information, the first user context information comprising one or more of a first user profile of a first user, a first goal of the first user and a current step in a process related to the first user;
receive, from the first terminal, a feedback signal corresponding to an interaction between the first user and the first agent; and
retrain a world model based on the feedback signal from the first terminal.

2. The self-learning massive agentic apparatus of claim 1, wherein the instructions, when executed by the at least one processor, cause the self-learning massive agentic apparatus to:
generate, based on the retrained world model, a second agent for a second user, the second agent generated based on a similarity between second user context information of the second user and the first user context information; and
propagate the second agent to a second terminal of the second user.

3. The self-learning massive agentic apparatus of claim 2, wherein the instructions, when executed by the at least one processor, cause the self-learning massive agentic apparatus to:
input the second user context information of the second user into an Agent Generation Model (AGM), the second user context information comprising one or more of a second user profile of the second user, a second goal of the second user and a current step in a process related to the second user, and
wherein the AGM is configured to:
identify a plurality of candidate agents from an agent space;
simulate performance outcomes for the plurality of candidate agents by querying the retrained world model with information indicating the plurality of candidate agents and the second user context information; and
select, based on the simulated performance outcomes, the second agent from among the plurality of candidate agents.

4. The self-learning massive agentic apparatus of claim 3, wherein the instructions, when executed by the at least one processor, cause the self-learning massive agentic apparatus to:
apply a Bayesian optimization acquisition function to the simulated performance outcomes, via the AGM, to calculate a plurality of scores corresponding to the plurality of candidate agents,
wherein the Bayesian optimization acquisition function is configured to assign higher scores (i) to one or more candidate agents predicted to exceed a performance threshold with respect to a predefined goal, or (ii) to one or more candidate agents having a level of uncertainty of the performance prediction that exceeds an uncertainty threshold.

5. The self-learning massive agentic apparatus of claim 2, wherein the world model comprises a transformer configured to:
obtain latent representations based on the first user context information and the second user context information, and dynamically and implicitly identify a similarity between the latent representations.

6. The self-learning massive agentic apparatus of claim 1, wherein the first agent comprises a configuration for one or more first user interface (UI) components to be output at the first terminal.

7. The self-learning massive agentic apparatus of claim 1, wherein the first agent comprises a configuration for an interactive content to be output at the first terminal.

8. The self-learning massive agentic apparatus of claim 2, wherein the first agent comprises a first configuration for one or more first user interface (UI) components to be output at the first terminal, and
wherein the second agent comprises a second configuration for one or more second UI components to be output at the second terminal, the one or more second UI components customized based on the one or more first UI components.

9. The self-learning massive agentic apparatus of claim 1, wherein the feedback signal comprises a performance result corresponding to the interaction between the first user and the first agent.

10. The self-learning massive agentic apparatus of claim 2, wherein the first goal of the first user is an improvement in a cumulative grade, the feedback signal comprises a first exam score from the first user, the second agent comprises a personalized lesson plan generated based on the first exam score of the first user, and
wherein the propagation of the second agent comprises transmitting the personalized lesson plan to the second terminal.

11. A self-learning massive agentic method, comprising:
propagating, to a first terminal, a first agent based on first user context information, the first user context information comprising one or more of a first user profile of a first user, a first goal of the first user and a current step in a process related to the first user;
receiving, from the first terminal, a feedback signal corresponding to an interaction between the first user and the first agent; and
retraining a world model based on the feedback signal from the first terminal.

12. The method of claim 11, further comprising:
generating, based on the retrained world model, a second agent for a second user, the second agent generated based on a similarity between second user context information of the second user and the first user context information; and
propagating the second agent to a second terminal of the second user.

13. The method of claim 12, further comprising:
inputting the second user context information of the second user into an Agent Generation Model (AGM), the second user context information comprising one or more of a second user profile of the second user, a second goal of the second user and a current step in a process related to the second user, and
wherein the AGM is configured to:
identify a plurality of candidate agents from an agent space;
simulate performance outcomes for the plurality of candidate agents by querying the retrained world model with information indicating the plurality of candidate agents and the second user context information; and
select, based on the simulated performance outcomes, the second agent from among the plurality of candidate agents.

14. The method of claim 13, further comprising:
applying a Bayesian optimization acquisition function to the simulated performance outcomes, via the AGM, to calculate a plurality of scores corresponding to the plurality of candidate agents,
wherein the Bayesian optimization acquisition function is configured to assign higher scores (i) to one or more candidate agents predicted to exceed a performance threshold with respect to a predefined goal, or (ii) to one or more candidate agents having a level of uncertainty of the performance prediction that exceeds an uncertainty threshold.

15. The method of claim 12, wherein the world model comprises a transformer configured to:
obtain latent representations based on the first user context information and the second user context information, and dynamically and implicitly identify a similarity between the latent representations.

16. The method of claim 11, wherein the first agent comprises a configuration for one or more first user interface (UI) components to be output at the first terminal.

17. The method of claim 11, wherein the first agent comprises a configuration for an interactive content to be output at the first terminal.

18. The method of claim 12, wherein the first agent comprises a first configuration for one or more first user interface (UI) components to be output at the first terminal, and
wherein the second agent comprises a second configuration for one or more second UI components to be output at the second terminal, the one or more second UI components customized based on the one or more first UI components.

19. The method of claim 12, wherein the first goal of the first user is an improvement in a cumulative grade, the feedback signal comprises a first exam score from the first user, the second agent comprises a personalized lesson plan generated based on the first exam score of the first user, and
wherein the propagation of the second agent comprises transmitting the personalized lesson plan to the second terminal.

20. A non-transitory computer-readable recording medium having instructions recorded thereon, that, when executed by at least one processor, individually or collectively, cause the at least one processor to:
propagate, to a first terminal, a first agent based on first user context information, the first user context information comprising one or more of a first user profile of a first user, a first goal of the first user and a current step in a process related to the first user;
receive, from the first terminal, a feedback signal corresponding to an interaction between the first user and the first agent; and
retrain a world model, based on the feedback signal from the first terminal.
